(19) United States
(12) Patent Application Publication
(10) Pub. No.: US 2012/0144676 A1
(43) Pub. Date: Jun. 14, 2012

(54) MULTI-BLADE ACCESSORIES

(76) Inventors: Richard Davidian, Pickens, SC (US); Robert E. McCracken, Anderson, SC (US); Kenneth M. Brazell, Piedmont, SC (US)

(21) Appl. No.: 13/324,189

(22) Filed: Dec. 13, 2011

Related U.S. Application Data
(60) Provisional application No. 61/422,959, filed on Dec. 14, 2010.

(51) Int. Cl. B26D 1/25

(52) U.S. Cl. 30/142

(57) ABSTRACT

An accessory attachable to an output shaft of a power tool includes a hub portion having an opening for securing the accessory to the power tool, a first blade portion having a first side edge extending away from the hub portion, and a second blade portion having a second side edge extending away from the hub portion in a direction different from the first side edge. The first blade portion has a first working characteristic, and the second blade portion has a second working characteristic different from the first working characteristic. The first side edge is substantially perpendicular to the second side edge.

### CROSS-REFERENCE TO RELATED APPLICATION

This application claims priority to co-pending U.S. Provisional Patent Application No. 61/422,959 filed on Dec. 14, 2010, the entire contents of which are incorporated herein by reference.

### BACKGROUND OF THE INVENTION

The present invention relates to accessories for an oscillating multi-tool.

FIG. 1 illustrates one example of an oscillating multi-tool 10 that receives interchangeable accessories. The oscillating multi-tool 10 converts rotary motion of a motor 12 and motor drive shaft 14 into oscillating motion of an output shaft 16. The output shaft 16 includes an arbor 18 that receives an accessory 20, such as a blade, which oscillates with the output shaft 16 and does work on a work piece.

### SUMMARY

In one construction, the invention provides an accessory attachable to an output shaft of a power tool. The accessory includes a hub portion having an opening for securing the accessory to the power tool, a first blade portion having a first side edge extending away from the hub portion, and a second blade portion having a second side edge extending away from the hub portion in a direction different from the first side edge. The first blade portion has a first working characteristic, and the second blade portion has a second working characteristic different from the first working characteristic. The first side edge is substantially perpendicular to the second side edge.

In another construction, the invention provides an accessory attachable to an output shaft of a power tool. The accessory includes a hub portion having an opening for securing the accessory to the power tool, the opening having a central axis. The accessory also includes a first blade portion extending away from the hub portion and a second blade portion extending away from the hub portion in a direction substantially opposite the first blade portion. The first blade portion has a first working characteristic, and the second blade portion has a second working characteristic different from the first working characteristic. The accessory also includes a third blade portion extending away from the hub portion in a direction substantially perpendicular to the first and second blade portions, the third blade portion having a third working characteristic different from the first and second working characteristics.

In yet another construction, the invention provides an accessory attachable to an output shaft of a power tool. The accessory includes a hub portion having an opening for securing the accessory to the power tool, the opening having a central axis. The accessory also includes a first blade portion extending away from the hub portion and a second blade portion extending away from the hub portion in a direction different from the first blade portion. The first blade portion includes a first edge having a first working characteristic, and the second blade portion includes a second edge having a second working characteristic different from the first working characteristic. The first working characteristic is spaced apart from the second working characteristic. One of the first and second working characteristics includes one of teeth arranged substantially along a straight line, teeth arranged substantially along an arc defining an arc center that substantially coincides with the central axis, and a smooth sharp edge shaped as an arc defining an arc center that substantially coincides with the central axis.

In yet another construction, the invention provides an accessory attachable to an output shaft of a power tool. The accessory includes a hub portion having an opening for securing the accessory to the power tool, the opening having a central axis. The accessory also includes a utility portion including a first edge having a first working characteristic and a second edge having a second working characteristic different from the first working characteristic. The first edge is substantially arcuate and has a first arc center that substantially coincides with the central axis. The second edge is substantially arcuate and has a second arc center that substantially coincides with the central axis. The first edge and the second edge meet at a junction. The first edge extends between the junction and a first end, and the second edge extends between the junction and a second end. The accessory also includes an arc-shaped recess separating the first end from the second end.

Other aspects of the invention will become apparent by consideration of the detailed description and accompanying drawings.

### DESCRIPTION OF THE DRAWINGS

FIG. 1 is a side view of an oscillating multi-tool receiving a prior art accessory.

FIG. 2 is a top view of an accessory according to one construction of the invention.

FIG. 3 is a top perspective view of the accessory of FIG. 2.

FIG. 4 is a top view of an accessory according to another construction of the invention.

FIG. 5 is a top view of an accessory according to yet another construction of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

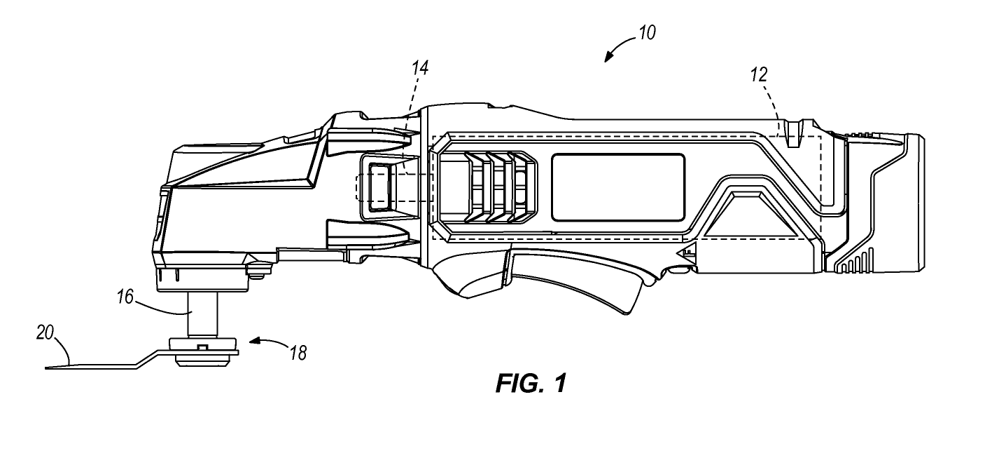

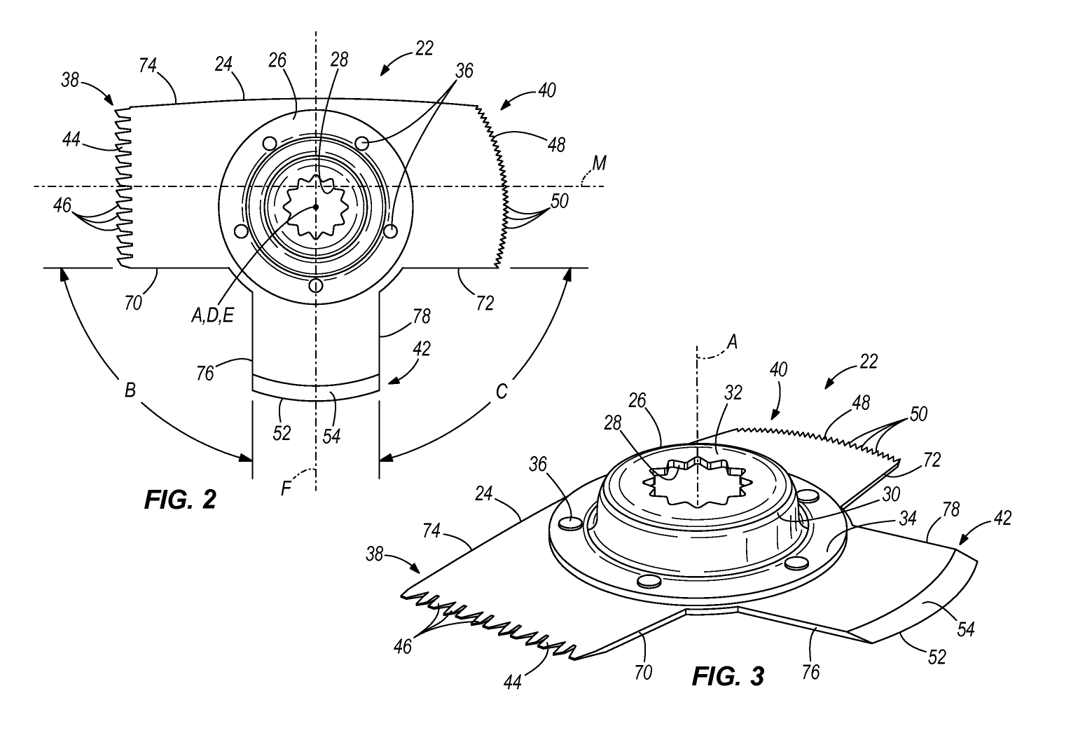

FIGS. 2-3 illustrate an accessory 22 according to one construction of the invention. The accessory 22 is selectively attachable to an oscillating multi-tool, such as the multi-tool 10 shown in FIG. 1 and described above. The accessory 22 includes a utility portion 24 and an attachment portion 26, or hub portion. The attachment portion 26 includes an opening 28 for receiving the arbor 18 of the multi-tool 10. The opening 28 in the illustrated construction is a 12-point star having twelve sharp triangular points arranged in a circular configuration about a central axis A. As best illustrated in FIG. 3, the attachment portion 26 includes a substantially cylindrical portion 30 having a planar end portion 32 and a flange portion 34 extending from the cylindrical portion 30 generally opposite the planar end portion 32. The flange portion 34 lies in a plane substantially parallel to the planar end portion 32. The opening 28 is positioned substantially centrally in the planar end portion 32. In other constructions, other attachment portions suitable for attaching the accessory 22 to an oscillating multi-tool may be employed. For example, other attachment portions may be planar, flush with the utility portion 24, or formed integrally with the utility portion 24. In the illustrated construction, the attachment portion 26 is coupled to the utility portion 24 by rivets 36. In other constructions, other fasteners may be employed, the attachment portion and utility portion may be welded or glued together or formed integrally. In yet other constructions, the opening 28 may have another suitable shape for attaching to an output shaft 16 of an oscillating tool 10 and may include more than one opening, such as a series of openings arranged radially about the central axis A, or a combination of a central opening and radial openings.

The utility portion 24 includes a first blade portion 38, a second blade portion 40 and a third blade portion 42. Each of the first, second and third blade portions 38, 40, 42 extend generally away from the attachment portion 26, each in a different direction. The first blade portion 38 includes a first working edge 44 having a first working characteristic. In the illustrated construction, the first working edge 44 is substantially straight and includes asymmetrical teeth 46 particularly suited for cutting wood. The asymmetrical teeth 46 are generally aligned along a substantially straight line.

The second blade portion 40 includes a second working edge 48 having a second working characteristic different from the first working characteristic. The second working edge 48 is curved and includes symmetrical triangular teeth 50 arranged along the curve. In the illustrated construction the curve of the second working edge 48 is substantially an arc having an arc center D that substantially coincides with the central axis A. The symmetrical triangular teeth 50 are particularly suited for cutting metal. The second edge 48 includes a greater number of teeth than the first edge 44. Furthermore, the second edge 48 includes higher concentration of teeth, or a greater number of teeth per inch, than the first working edge 44.

The third blade portion 42 includes a third working edge 52 having a third working characteristic different from the first working characteristic and the second working characteristic. The third working edge 52 includes a beveled surface 54 such that the third working edge 52 is a smooth, sharp arc-shaped edge tapering to a point and particularly suited for scraping. The third working edge 52 defines an arc center E that substantially coincides with the central axis A and with the arc center D of the second working edge 48. Furthermore, the third blade portion 42 extends along a longitudinal axis F generally radially away from the central axis A of the attachment portion 26. The longitudinal axis F intersects the central axis A and the arc center E of the third working edge 52.

In other constructions, the utility portion 24 may include two, four or more blade portions. In yet other constructions, the working characteristic of any of the blade portions may include size of teeth, shape of teeth, number of teeth, concentration of teeth, shape of edge, curve of edge, straightness of edge, sharpness, smoothness, grit, coarseness, other working characteristics, or any combination thereof. The working characteristics are not limited to the edge of the blade portions. For example, in some constructions, a blade portion may be a sanding portion configured to receive sandpaper or may be a grinding portion including a coarse surface for grinding, or the like.

The first, second and third blade portions 38, 40, 42 are coupled to form a single piece. In the illustrated construction, the first, second and third blade portions 38, 40, 42 are formed as a single piece. In other constructions, the first, second and third blade portions 38, 40, 42 may be coupled by welding, fastening with fasteners, or coupled individually to the attachment portion 26 (as if to a central hub).

The first, second and third blade portions 38, 40, 42 lie in a plane substantially normal to the central axis A and different from and parallel to the planar end portion 32, which includes the opening 28. The first blade portion 38 extends away from the central axis A in a first direction and includes a first side edge 70. The second blade portion 40 extends away from the central axis A in a second direction generally opposite the first direction, e.g., approximately 180 degrees apart, which defines a central longitudinal axis M through the first and second blade portions 38, 40. The second blade portion 40 includes a second side edge 72. The second side edge 72 is substantially parallel with the first side edge 70. In the illustrated construction, the second side edge 72 is substantially collinear with the first side edge 70. The first and second blade portions 38, 40 also share a third side edge 74, which is slightly curved. The first working edge 44 is adjacent or abuts the first side edge 70 and the third side edge 74 and extends between the first side edge 70 and the third side edge 74. Similarly, the second working edge 48 is adjacent or abuts the second side edge 72 and the third side edge 74 and extends between the second and third side edges 72, 74.

The third blade portion extends generally radially away from the central axis A in a third direction intermediate the first direction and the second direction and includes a fourth side edge 76 and a fifth side edge 78 substantially parallel to the fourth side edge 76. The third working edge 52 is adjacent or abuts the second fourth side edge 76 and the fifth side edge 78 and extends between the fourth side edge 76 and the fifth side edge 78.

The third blade portion 42 is positioned at an angle B from the first blade portion 38 and at an angle C from the second blade portion 40. More specifically, the fourth side edge 76 is positioned at the angle B from the first side edge 70, and the fifth side edge 78 is positioned at the angle C from the second side edge 72. In the illustrated construction, the angles B and C are approximately 90 degrees. Furthermore, the longitudinal axis M of the first and second blade portions 38, 40 is substantially perpendicular to the longitudinal axis F of the third blade portion 42. In other constructions, the angles B and C may be greater than or less than 90 degrees and need not be the same. In yet other constructions, the first and second blade portions 38, 40 need not be positioned generally opposite from each other and may be positioned at an acute angle relative to each other.

In the illustrated construction, the longitudinal axis M does not intersect the central axis A. However, in other constructions, the first, second and third side edges 70, 72, 74 may be shaped and positioned such that the first and second blade portions 38, 40 define respective central longitudinal axes that do intersect the central axis A.

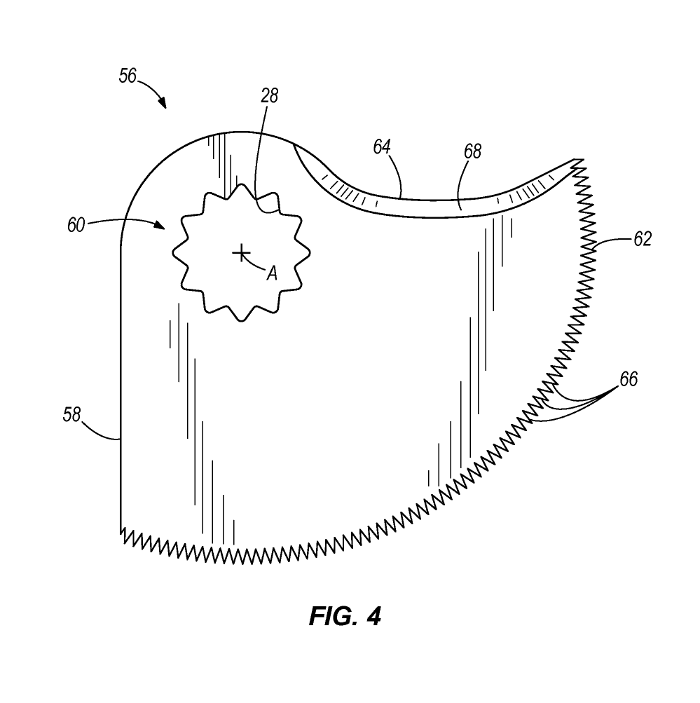

FIG. 4 illustrates an accessory 56 according to another construction of the invention. The accessory 56 is selectively attachable to an oscillating multi-tool, such as the multi-tool 10 shown in FIG. 1 and described above. The accessory 56 includes a utility portion 58 and an attachment portion 60. The attachment portion 60 includes the opening 28, as described above. The attachment portion 60 is substantially planar and flush with the utility portion 58 and formed as one piece with the utility portion 58. In other constructions, the opening 28 may have another suitable shape for attaching to an output shaft 16 of an oscillating tool 10 and may include more than one opening, such as a series of openings arranged radially about the central axis A, or a combination of a central opening and radial openings.

The utility portion 58 is substantially planar and formed as a single piece. The utility portion 58 includes a first edge 62 having a first working characteristic for performing a function on a work piece and a second edge 64 having a second working characteristic different from the first working characteristic for performing a different function on a work piece. In the illustrated construction, the first edge 62 is substantially arc-shaped and includes symmetrical triangular teeth 66 particularly suited for cutting wood or metal. The first edge 62 is substantially concave with respect to the central axis A (or convex relative to a user). The symmetrical teeth 66 are generally aligned along the arc that defines the first edge 62. The arc-shape of the first edge 62 is not centered about the central axis A, i.e., not coaxial with the central opening 28. The utility portion 58 is substantially normal to the central axis A.

The second edge 64 is curved and includes a beveled surface 68 along the curve. The second edge 64 is substantially convex with respect to the central axis A (or concave relative to a user). The curvature of the second edge 64 is opposite the curvature of the first edge 62 with respect to the central axis A. The second edge 64 is a smooth, sharp curved edge particularly suited for performing a razor function.

In other constructions, the utility portion 58 may include three, four or more edges having third, fourth, or more working characteristics, respectively, for performing different functions on a work piece. In yet other constructions, the working characteristic of any of the edge portions may include size of teeth, shape of teeth, number of teeth, concentration of teeth, shape of edge, curve of edge, straightness of edge, sharpness, smoothness, grit, coarseness, other working characteristics, or any combination thereof. The working characteristics are not limited to the edge of the blade portions. For example, in some constructions, a portion of the utility portion 58 may be a sanding portion configured to receive sandpaper or may be a grinding portion including a coarse surface for grinding, or the like.

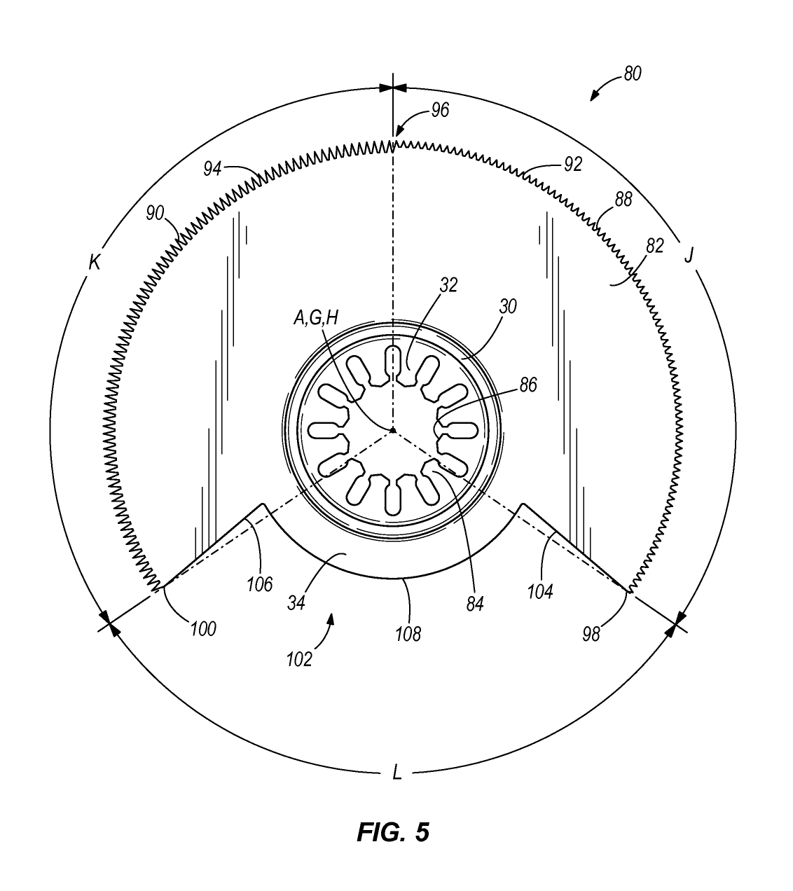

FIG. 5 illustrates an accessory 80 according to another construction of the invention. The accessory 80 is selectively attachable to an oscillating multi-tool, such as the multi-tool 10 shown in FIG. 1 and described above. The accessory 80 includes a utility portion 82 and an attachment portion 84. The attachment portion 84 includes an opening 86, similar to the opening 28 described above, for attaching to the arbor 18 of a multi-tool 10. In other constructions, the opening 86 may have another suitable shape for attaching to an output shaft 16 of an oscillating tool 10 and may include more than one opening, such as a series of openings arranged radially about the central axis A, or a combination of a central opening and radial openings.

The attachment portion 84 is similar to the attachment portion 26 described above and best illustrated in FIG. 3, including a cylindrical portion 30 having a planar end portion 32 and a flange portion 34 extending from the cylindrical portion 30 generally opposite the planar end portion 32. The flange portion 34 lies in a plane substantially parallel to the planar end portion 32. In the illustrated construction, the flange portion 34 (and furthermore the attachment portion 26) is formed integrally with the utility portion 82. In other constructions, the utility portion 82 may be formed separately from the attachment portion 84 and the attachment portion 84 may be fastened to the utility portion 82, as described above with respect to FIG. 3. The utility portion 82 lies in a plane spaced from and substantially parallel to the planar end portion 32, which includes the opening 86. The utility portion 82 and the planar end portion 32 are connected by the cylindrical portion 30.

The utility portion 82 is substantially planar and formed as a single piece and lies substantially normal to the central axis A. The utility portion 82 includes a first edge 88 having a first working characteristic for performing a function on a work piece and a second edge 90 having a second working characteristic different from the first working characteristic for performing a different function on a work piece. The first edge 88 and second edge 90 are contiguous and meet at a junction 96 that is substantially uninterrupted, i.e., transitions or blends smoothly. The first edge 88 and the second edge 90 lie at substantially the same radial distance from the central axis A. The first edge 88 extends between the junction 96 and a first end 98, and the second edge 90 extends between the junction 96 and a second end 100.

In the illustrated construction, the first edge 88 is substantially arc-shaped and includes symmetrical triangular teeth 92 having a first size and shape aligned along the arc. The first edge 88 defines an arc center G that substantially coincides with the central axis A of the opening 86. The first edge 88 extends circumferentially about the central axis A by an angle J, measured between the junction 96 and the first end 98 with respect to the central axis A. The angle J is preferably between about 100 and about 140 degrees, and more preferably between about 110 degrees and about 130 degrees. In the illustrated construction, the angle J is approximately 123 degrees.

The second edge 90 is substantially arc-shaped and includes symmetrical triangular teeth 94 having a second size and shape aligned along the arc, the second size and shape being different from the first size and shape. The second edge 90 defines an arc center H that substantially coincides with the central axis A of the opening 86 and with the arc center G of the first edge 88. The second edge 90 extends circumferentially about the central axis A by an angle K, measured between the junction 96 and the second end 100 with respect to the central axis A. The angle K is preferably between about 100 and about 140 degrees, and more preferably between about 110 degrees and about 130 degrees. In the illustrated construction, the angle K is approximately 123 degrees.

The first end 98 and the second end 100 are not contiguous and are spaced apart from each other by an angular or arc-shaped gap or recess 102 having an angle L, measured between the first end 98 and the second end 100 with respect to the central axis A. In the illustrated construction, the arc-shaped gap 102 has an angle L of approximately 114 degrees. Of course, it is understood that the size of the arc-shaped gap 102 depends on the angular length J, K of the first edge 88 and the second edge 90. Preferably, the angle L is between about 80 and about 160 degrees. More preferably, the angle L is between about 100 and about 140 degrees. The arc-shaped gap 102 is bounded by a first straight bounding edge 104, a second straight bounding edge 106 and a circumferential bounding edge 108 extending between the first and second straight bounding edges 104, 106. The circumferential bounding edge 108 is substantially arc-shaped and is substantially concentric with the central axis A and lies at a distance from axis A less than a respective distance from axis A of the first edge 88 and the second edge 90. The first straight bounding edge 104 extends between the first end 98 and the circumferential bounding edge 108, and the second straight bounding edge 106 extends between the second end 100 and the circumferential bounding edge 108. In the illustrated construction, the first straight bounding edge 104 does not lie exactly radial with respect to the central axis A, and the second straight bounding edge does not lie exactly radial with respect to the central axis A. In other words, the first and second straight bounding edges 104, 106 do not lie along lines that intersect the central axis A. In other constructions, the first and second straight bounding edges 104, 106 may be radial with respect to the central axis A.

In other constructions, the teeth 94 of the second edge 90 may differ from the teeth 92 of the first edge 88 by size, shape, concentration, symmetry, function, etc. In yet other constructions, the working characteristic of any of the edges may include size of teeth, shape of teeth, number of teeth, concentration of teeth, shape of edge, curve of edge, straightness of edge, sharpness, smoothness, grit, coarseness, other working characteristics, or any combination thereof. The working characteristics are not limited to the edge of the blade portions. For example, in some constructions, a portion of the utility portion 82 may be a sanding portion configured to receive sandpaper or may be a grinding portion including a coarse surface for grinding, or the like.

In operation, a user couples the attachment portion 26, 84 of the respective accessory 22, 56, 80 to the output shaft 16 of an oscillating tool 10 via the arbor 18. The attachment portion has rotational symmetry, and the accessory can therefore be attached to the arbor 18 of the tool 10 at multiple angles of rotation with respect to the tool 10. The user then operates the oscillating tool 10 to provide an oscillating motion to the accessory. The accessory provides two or more functions on a work piece, such as cutting, flush cutting, sawing, scraping, removing, sanding, grinding, filing, polishing, mold-making and the like. The accessory is attachable to the tool 10 at a plurality of angular orientations, and the user may choose to use the accessory for a first function, a second function and sometimes a third function without having to remove the accessory from the tool 10 and replace the accessory with a different accessory in order to perform the other function. In some cases, the user may reattach the accessory at a different angle of rotation with respect to the arbor 18 of the oscillating tool 10 to more effectively use a different edge or blade portion of the accessory.

Thus, the invention provides, among other things, a combination blade accessory, or multi-blade accessory, for performing a variety of functions on a work piece with a single piece attachable to an oscillating multi-tool. Various features and advantages of the invention are set forth in the following claims.

What is claimed is:

1. An accessory attachable to an output shaft of a power tool, the accessory comprising:
a hub portion having an opening for securing the accessory to the power tool;
a first blade portion having a first side edge extending away from the hub portion, the first blade portion having a first working characteristic; and
a second blade portion having a second side edge extending away from the hub portion in a direction different from the first side edge, the second blade portion having a second working characteristic different from the first working characteristic;
wherein the first side edge is substantially perpendicular to the second side edge.

2. The accessory of claim 1, wherein the first working characteristic includes a first working edge and the second working characteristic includes a second working edge.

3. The accessory of claim 2, wherein the first working edge includes one of teeth and a sharp smooth edge, wherein the first working edge abuts the first side edge.

4. The accessory of claim 3, wherein the second working edge includes one of teeth and a sharp smooth edge, wherein the second working edge abuts the second side edge.

5. The accessory of claim 1, wherein the first working characteristic is spaced apart from the second working characteristic.

6. The accessory of claim 1, wherein one of the first and second working characteristics includes a substantially arc-shaped edge and wherein the other of the first and second working characteristics includes a substantially straight edge having teeth.

7. The accessory of claim 6, wherein the opening defines a central axis, and wherein the substantially arc-shaped edge has an arc center that substantially coincides with the central axis.

8. The accessory of claim 1, wherein the opening defines a central axis, wherein each of the first and second working characteristics includes a substantially arc-shaped edge and wherein each of the substantially arc-shaped edges defines an arc center that substantially coincides with the central axis.

9. The accessory of claim 1, wherein the first and second side edges are separated by an angular gap having an angle of substantially 90 degrees.

10. The accessory of claim 1, wherein the hub portion is located on a different plane from at least one of the first and second blade portions.

11. An accessory attachable to an output shaft of a power tool, the accessory comprising:
a hub portion having an opening for securing the accessory to the power tool, the opening having a central axis;
a first blade portion extending away from the hub portion, the first blade portion having first working characteristic;
a second blade portion extending away from the hub portion in a direction substantially opposite the first blade portion, the second blade portion having a second working characteristic different from the first working characteristic; and
a third blade portion extending away from the hub portion in a direction substantially perpendicular to the first and second blade portions, the third blade portion having a third working characteristic different from the first and second working characteristics.

12. The accessory of claim 11, wherein the first working characteristic is spaced apart from the second working characteristic, and wherein the second working characteristic is spaced apart from the third working characteristic.

13. The accessory of claim 11, wherein the first working characteristic includes a first working edge, the second working characteristic includes a second working edge and the third working characteristic includes a third working edge.

14. The accessory of claim 13, wherein the first working edge includes one of teeth and a sharp smooth edge, wherein the second working edge includes one of teeth and a sharp smooth edge and wherein the third working edge includes one of teeth and a sharp smooth edge.

15. The accessory of claim 13, wherein one of the first, second and third working edges includes a substantially arc-shaped edge and wherein another of the first, second and third working edges includes a substantially straight edge having teeth.

16. The accessory of claim 15, wherein the opening defines a central axis, and wherein the substantially arc-shaped edge has an arc center that substantially coincides with the central axis.

17. The accessory of claim 11, wherein the opening defines a central axis, wherein at least two of the first, second and third working characteristics include a substantially arc-shaped edge and wherein each of the substantially arc-shaped edges defines an arc center that substantially coincides with the central axis.

18. The accessory of claim 11, wherein the first working characteristic includes a first set of teeth having a first size, wherein the second working characteristic includes a second set of teeth having a second size different from the first size, and wherein the third working characteristic includes a sharp smooth edge.

19. The accessory of claim 18, wherein the first set of teeth are substantially arranged along an arc, wherein the second set of teeth are substantially arranged along a straight line, and wherein the sharp smooth edge is substantially arcuate.

20. The accessory of claim 19, wherein the opening defines a central axis, wherein the first set of teeth define a first arc center that substantially coincides with the central axis, and wherein the sharp smooth edge defines a second arc center that substantially coincides with the central axis.

21. The accessory of claim 11, wherein the hub portion is located on a different plane from at least one of the first, second and third blade portions.

22. An accessory attachable to an output shaft of a power tool, the accessory comprising:
a hub portion having an opening for securing the accessory to the power tool, the opening having a central axis;
a first blade portion extending away from the hub portion, the first blade portion including a first edge having first working characteristic; and
a second blade portion extending away from the hub portion in a direction different from the first blade portion, the second blade portion including a second edge having a second working characteristic different from the first working characteristic;
wherein the first working characteristic is spaced apart from the second working characteristic; and
wherein one of the first and second working characteristics includes one of teeth arranged substantially along a straight line, teeth arranged substantially along an arc defining an arc center that substantially coincides with the central axis, and a smooth sharp edge shaped as an arc defining an arc center that substantially coincides with the central axis.

23. The accessory of claim 22, wherein the first working characteristic includes teeth arranged along an arc defining an arc center that substantially coincides with the central axis.

24. The accessory of claim 23, wherein the second working characteristic includes a substantially arcuate sharp smooth edge.

25. The accessory of claim 22, wherein the first working characteristic includes teeth arranged along a straight line.

26. The accessory of claim 25, wherein the second working characteristic includes a substantially arcuate sharp smooth edge.

27. The accessory of claim 22, wherein one of the first and second blade portions defines a central longitudinal axis that intersects the central axis.

28. The accessory of claim 27, wherein the other of the first and second blade portions defines a central longitudinal axis that does not intersect the central axis.

29. The accessory of claim 27, wherein the respective edge of the one of the first and second blade portions is substantially arc-shaped defining an arc center that substantially coincides with the central axis.

30. The accessory of claim 22, wherein the hub portion is located on a different plane from at least one of the first and second blade portions.

31. The accessory of claim 22, wherein the first working characteristic includes cutting teeth having a first size, and wherein the second working characteristic includes cutting teeth having a second size different from the first size.

32. The accessory of claim 22, wherein the accessory further comprises a third blade portion having a third working characteristic different from the first and second working characteristics, the third blade portion extending radially away from the opening.

33. An accessory attachable to an output shaft of a power tool, the accessory comprising:
a hub portion having an opening for securing the accessory to the power tool, the opening having a central axis;
a utility portion including a first edge having a first working characteristic and a second edge having a second working characteristic different from the first working characteristic, the first edge being substantially arcuate and having a first arc center that substantially coincides with the central axis, the second edge being substantially arcuate and having a second arc center that substantially coincides with the central axis;
wherein the first edge and the second edge meet at a junction, and wherein the first edge extends between the junction and a first end, and wherein the second edge extends between the junction and a second end;
the accessory further comprising an arc-shaped recess separating the first end from the second end.

34. The accessory of claim 33, wherein the first working characteristic includes teeth having a first size and the second working characteristic includes teeth having a second size different from the first size.

35. The accessory of claim 33, wherein the first edge lies at a first radial distance from the central axis, wherein the arc-shaped recess is bounded by a first straight edge, a second straight edge and a circumferential edge, the circumferential edge extending in an arc about the central axis at a second radial distance that is less than the first radial distance.

36. The accessory of claim 35, wherein the first straight edge and the second straight edge are not radial with respect to the central axis.

37. The accessory of claim 33, wherein the opening lies in a first plane, and wherein the utility portion lies in a second plane different from the first plane and parallel to the first plane.
